(19) United States
(12) Patent Application Publication
(10) Pub. No.: US 2022/0063314 A1
(43) Pub. Date: Mar. 3, 2022

(54) CYLINDRICAL PRINTING DEVICES

(71) Applicant: HEWLETT-PACKARD DEVELOPMENT COMPANY, L.P., Spring, TX (US)

(72) Inventors: Matthew William Tivnon, 10300 Energy Drive, TX (US); Owen P. Columbus, Spring, TX (US); Ken Maclean, Spring, TX (US); Mickey Chia-Yu Yuan, Spring, TX (US); Yun Fei Zhu, Shanghai (CN)

(73) Assignee: HEWLETT-PACKARD DEVELOPMENT COMPANY, L.P., Spring, TX (US)

(21) Appl. No.: 17/420,731

(22) PCT Filed: Jan. 9, 2019
(86) PCT No.: PCT/US2019/012832

§ 371 Date: Jul. 6, 2021

(51) Int. Cl. B41J 29/02; B41J 2/32

(52) U.S. Cl. CPC B41J 29/02; B41J 2/32

(57) ABSTRACT

A vertical column printing device may include a print engine formed within a base housing of the vertical column printing device; a door biased by a spring away from the print engine to be selectively opened to expose the print engine; and a geared platen formed on the door to interface with the print engine to drive a roll of paper past the print engine when the door is engaged with the based housing.

### BACKGROUND

Printing devices allow for a user to print off certain images and text in the form of a “hard-copy” of that data. This may allow for the mobile transfer of information to those who do not have access to a computing device at any given time. This is especially true at a point-of-sale (POS) location where receipts are printed and provided to a customer representing the prices paid for the goods and/or services purchased.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a vertical column printing device according to an example of the principles described herein.

FIG. 2 is a block diagram of a receipt printing device according to an example of the principles described herein.

FIG. 3 is a block diagram of a thermal receipt printing device according to an example, of the principles described herein.

FIGS. 4 and 5 is a perspective view of the thermal receipt printing device of any of FIGS. 1-3 according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Printing devices provide a physical copy of images and/or text for distribution of information. This may be especially true for those situations such at a POS location. Indeed, the receipt printing devices at these POS locations may provide to customers verification of a purchase goods and/or services in various levels of details. However, during use, the media such as paper may run out and the associate using the receipt printing device may reload the receipt printing device with additional media. In some examples, this media may come in the form of rolls of media that are loaded into the receipt printing device. However, the reloading process may be cumbersome due to the exactness used in the reloading process so that the printhead used to print onto the media may do so. Misalignment may cause the media to bunch up and the printed receipt not to be printed. by reducing any media misalignment errors and rendering the receipt printing device relatively more user-friendly, the entities implementing the receipt printing device may reduce the costs of training and use associated with the receipt printing device.

The present specification describes vertical column printing device that includes a print engine formed within a base housing of the vertical column printing device; a door biased by a spring away from the print engine to be selectively opened to expose the print engine; and a geared platen formed on the door to interface with the print engine to drive a roll of paper past the print engine when the door is engaged with the based housing.

The present specification also describes a receipt printing device that includes a base portion housing a printhead, the base portion in the form of a cylinder; a door portion coupled to the base portion via a hinge and a latching mechanism; and a rotational portion on top portion of the base portion that disengages the latching mechanism to unlatch the door portion from the base portion; wherein the door portion, when unlatched, extends laterally from the cylinder base portion a distance and, upon reaching a maximum extension from the cylinder base, hinges away from the base portion housing to reveal a spool of paper on the door

The present specification further describes a thermal receipt printing device that includes a cylindrical base housing; a print engine formed within the cylindrical base housing; a door biased by a spring away from the print engine to be selectively opened to expose the print engine, the door including: a spool to hold a roll of thermally activated paper; and a geared platen formed on the door to interface with the print engine to drive the roll of thermally activated paper past the print engine when the door is engaged with the based housing; and a latching mechanism comprising a hook formed on the base portion and a peg formed on the door; and a rotational top portion formed on the cylindrical base portion that, when rotated, disengages the peg from the hook so that the door may extend laterally from the base portion a distance and then swing away from the base portion using a hinge.

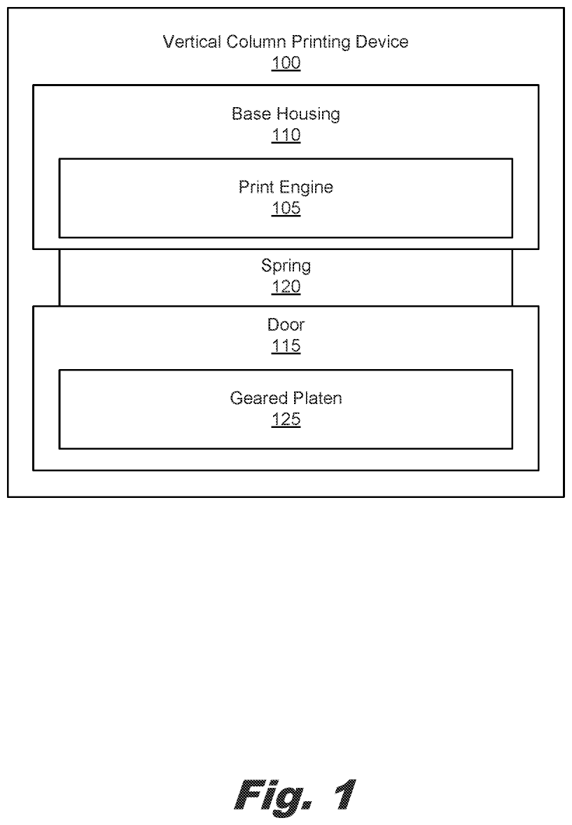

Turning now to the figures, FIG. 1 is a block diagram of a vertical column printing device (100) according to an example of the principles described herein. In an example, the vertical column printing device (100) is arranged in such a way that the print engine (105) is oriented vertically and prints images and text onto the media such that the images and text appear sideways on the media until the media is ripped or torn away and presented to, for example, the customer. Other elements and parts of the vertical column printing device (100) may be placed vertical as well as is described herein in order to orient the entire vertical column printing device (100) vertically.

The vertical column printing device (100) may include a base housing (110) that houses the print engine (105). The base housing (110) may be formed into a portion of a column with a door (115) forming a second part of the column as described herein. In an example, the base housing (110) may include a weight located at, for example, a bottom portion of the vertical column printing device (100). The weight may be heavy enough so as to prevent the movement of the vertical column printing device (100) when, for example, a portion of the media is ripped or cut away from a remaining portion of the media. In an example, the base housing (110) may include a screw interface that may receive a screw from a counter or other support structure the vertical column printing device (100) is resting on. In this example, when the screws engage the screw interface, the vertical column printing device (100), via the base housing (110), may be secured to the support structure the vertical column printing device (100) is resting on.

The vertical column printing device (100) may further include a door (115). The door (115), in any example presented herein, may be bimodal in that it may be presented in a closed state and against the base housing (110) or in an open state. In the closed state, the door (115) may create a columnar body with the base housing (110) in order to form the columnar shape of the vertical column printing device (100). When opened, the door (115) exposes the print engine (105) within the base housing (110) as well as a geared platen (125) coupled to the door (115).

The interface between the door (115) and base housing (110) may include a hinge that is spring-biased to separate a face of the door (115) from the base housing (110). This spring bias may be provided by a spring (120) located at any location between the base housing (110) and door (115) so as to force the door away from the base housing (110) when, for example, a latch on the base housing (110) is released from a pin, hook, or other surface on the door (115).

As described herein, the door (115) includes a geared platen (125) coupled thereto. The geared platen (125) may, when the door (115) is in the closed state, mechanically interfaces with a gear associated with the print engine (105). Upon mechanical interfacing of the geared platen (125) with the gear associated with the print engine (105), the media may be passed by the print engine (105) so that images and/or text may be printed onto the media. In this example, the geared platen (125) helps to progress the media through and out of the vertical column printing device (100) so that it may be torn off and presented to, for example, a customer.

In an example, the door (115) may be separated from the base housing (110), albeit at a hinged location, by twisting a twistable top portion of the vertical column printing device (100). In this example the twistable top portion may be a solid portion of the vertical column printing device (100) separate from both the door (115) and the base housing (110). This twistable top portion may, when twisted, unlatch a latch formed on the base housing (110) from a pin, hook, or other surface on the door (115). Because the door (115) is biased away from the base housing (110), the door may hinge away from the base housing (110) exposing the print engine (105) and geared platen (125) as described herein.

In an example, the door (115) may be separated from the base housing (110), albeit at a hinged location, by actuation of a button. The button may be a dedicated button that, when actuated, unlatches a latch formed on the base housing (110) from a pin, hook, or other surface on the door (115). Because the door (115) is biased away from the base housing (110), the door may hinge away from the base housing (110) exposing the print engine (105) and geared platen (125) as described herein.

In an example, the hinge of the vertical column printing device (100) may cause the door (115) to first extend away horizontally from the base housing (110) a distance and then be allowed to hinge away from the base housing (110). This dual action hinge allows for a first position of the door (115) to be achieved before a second position (i.e., a fully hinged away position) of the door (115). The distance of the door (115) from the base housing (110) after the door (115) has achieved the first position may be 4 mm. In another example, the distance of the door (115) from the base housing (110) after the door (115) has achieved the first position may be between 3 and 5 mm. The door (115) in the second position may open up the vertical column printing device (100) so that a user may insert a roll of media therein. The degree to which the door (115) may swing away from the base housing (110) at any degree including an up to 180 degrees from is closed position.

The vertical column printing device (100) also includes the print engine (105). The print engine (105) may be any device that applies an image and/or text to the media. In a specific example, the print engine (105) is a thermal print engine that cause an image to be applied to the media via use of a selective heating process. In this example, the media may be a thermal paper such as a thermochromic paper that, when heated, may change color at the locations of heat application. Although the print engine (105) described herein is a thermal print engine (105), the present specification contemplates the use of any other type of print engine (105) that implements, for example, ink or toner to apply the images/text to the print media.

The vertical column printing device (100) may further include a universal serial bus (USB) port. The USB port may provide for both the data and power to be sent to the vertical column printing device (100) when coupled to a data and power source. In the example where the vertical column printing device (100) is being implemented in a POS environment, the data and electrical coupling may be between a cash register and the vertical column printing device (100). In another example, the vertical column printing device (100) may include a second electrical/data connection to a cash drawer separate from a computing device. In this example, the computing device may send data through the vertical column printing device (100) and to the cash drawer such that signals to both the vertical column printing device (100) and cash drawer are received by the vertical column printing device (100). Any additional data/power ports may be formed on the vertical column printing device (100) so as to accommodate for any other or number of different peripheral devices such as flash drives, external hard drives, and the like. The present specification, therefore, contemplates the use of the vertical column printing device (100) in connection with any other type of computing device and/or peripheral device which may suit any particular environment.

The vertical column printing device (100) may further include a knife used to tear away or cut a portion of the media from a remainder of that media. In an example, the vertical column printing device (100) may include an internal knife that precuts the media after printing so that the user may pull the printed media out of the vertical column printing device (100). In an example, the vertical column printing device (100) may have a serrated edge placed at a location where the printed media exits the vertical column printing device (100). In this example, the serrated edge may assist a user in tearing the media away from a remaining portion of the media.

During operation of the vertical column printing device (100), the user may determine that media is to be inserted into the vertical column printing device (100) or that the media may be resupplied. When this occurs, the user may cause the door (115) to swing out from and hinge away from the base housing (110) using either of the twistable top portion or button as described herein. When the door (115) is opened, the user may insert the media. In an example, the media is in the form of a roll of paper. In an example, the roll of paper may be inserted onto a dowel or spool so as to maintain the roll of media in the door (115). When the media has been inserted, the user may take a length of the media and extend it beyond an outer surface of the base housing (110) of the vertical column printing device (100). Having the length of media in hand, the user may, with the other hand, close the door (115) against the base housing (110) so as to cause the latch on the base housing (110) to couple and lock to the pin, hook, or other surface formed on the door (115). Data and power may be provided to the vertical column printing device (100) to cause the print engine (105) to operate and print on the media.

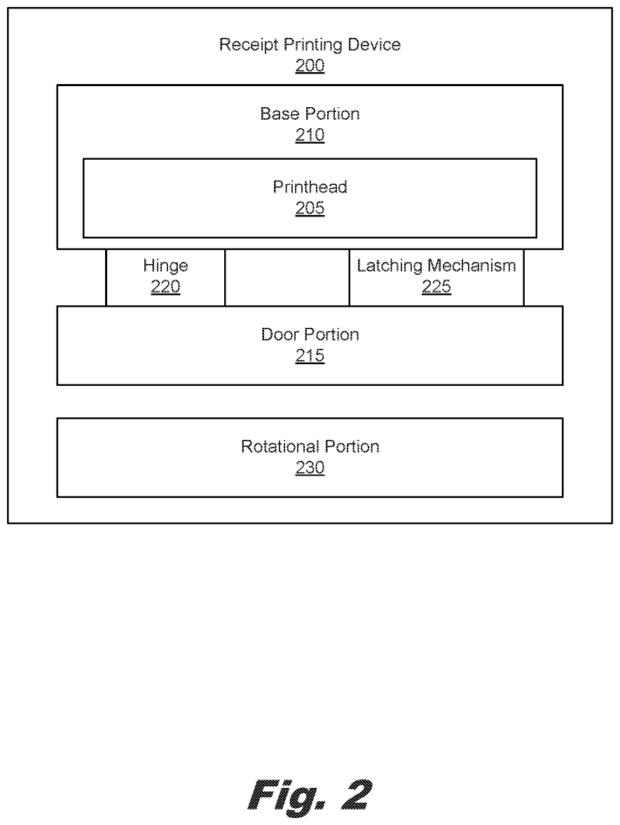

FIG. 2 is a block diagram of a receipt printing device (200) according to an example of the principles described herein. The receipt printing device (200) may include a base portion (210) that houses a printhead (205) and a door portion (215). The door portion (215) may be mechanically coupled to the base portion (210) via a hinge (220). In an example, the door portion (215) may be selectively mechanically coupled to the base portion (210) via a latching mechanism (225). In the present specification and in the appended claims, the term “selectively” is meant to be understood as a situation that is present in a way that involves the selection of a particular place or thing. Thus, a selective mechanical coupling means that the coupling may occur at a point in time whereas may not occur at another point in time. Because the door portion (215) may be unlatched from the base portion (210), it is selectively coupled to the base portion (210) using the latching mechanism (225). When the latching mechanism (225) is so actuated so as to unlatch the door portion (215) from the base portion (210), the door portion (215) may be removed from the base portion (210) at a location while maintaining a mechanical coupling with the base portion (210) via the hinge (220).

The receipt printing device (200) may also include a rotational portion (230) formed on a top portion of the base portion (210). The rotational portion (230) may be rotated by a user to disengage the latching mechanism (225) to unlatch the door portion (215) from the base portion (210). In a specific example, rotation of the rotational portion (230) causes a latch of the latching mechanism (225) in the base portion (210) to be unlatched from a pin or other surface on the door portion (215). When the latching mechanism (225) unlatches the door portion (215) from the base portion (210), the door portion (215) may extend laterally from the base portion (210) a distance and, upon reaching a maximum extension from the cylinder base, hinges away from the base portion (210) housing to reveal a spool of paper on the door portion (215).

As described herein, the latching mechanism (225) used to secure the door portion (215) to the base portion (210) may include a hook formed on the base portion (210) that interfaces with a peg or other similar surface formed on the door portion (215). The hook may be arranged so that reengagement of the peg with the hook allows for the latching mechanism (225) to latch the door portion (215) to the base portion (210).

The receipt printing device (200) may also include a geared platen formed on the door portion (215). The geared platen may engage with a gear associated with the printhead (205) such that, when the door portion (215) is interfaced with the base portion (210), the geared platen may help drive the media through and out of the receipt printing device (200) as described herein.

As described herein, the receipt printing device (200) may also include a weight. The weight may be formed within a bottom portion of the base portion (210) so as to provide stability and rotational resistance when the rotational portion on top portion of the base portion (210) is rotated and/or when a portion of the media is torn away from a remaining portion of the media.

As descried herein, the door portion (215), when unlatched from the base portion (210), may extend laterally from the base portion (210) a distance and, upon reaching a maximum extension from the base portion (210), may hinge away from the base portion (210) via the hinge (220). In an example, the maximum extension may be 4 mm. In an example, the maximum extension may be between 3 mm and 5 mm. After the door portion (215) is extended from the base portion (210), the hinge (220) may allow for the door portion (215) to hinge away from the base portion (210) further thereby exposing to a user the spool, geared platen, and printhead (205) as described herein.

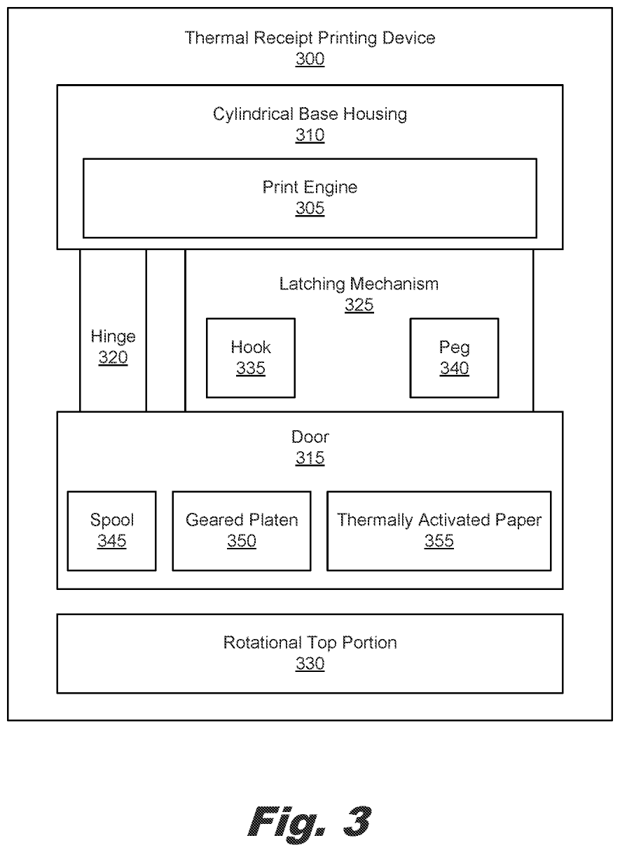

FIG. 3 is a block diagram of a thermal receipt printing device (300) according to an example, of the principles described herein. The thermal receipt printing device (300) may include a cylindrical base housing (310) and a door (315) selectively coupled to the cylindrical base housing (310).

The cylindrical base housing (310) may house a print engine (305) such as a thermal print engine (305). The print engine (305) may have a gear that interfaces with a geared platen (350) formed on the door (315) of the thermal receipt printing device (300). Upon activation of the print engine (305), the gear may cause the geared platen (350) to move a media through the thermal receipt printing device (300).

The door (315) may include a spool (345). The spool (345) may be formed on a shelf formed on the door (315). The spool (345) may be formed to quickly receive a roll of media such as the thermally activated media described herein. The distance from the spool (345) to the geared platen (350) may be such that the roll of media may fit therebetween. In an example, the spool (345) may be spring-biased towards the geared platen (350) such that as the media is consumed, the media remains biased towards the geared platen (350) so that it may be passed through the thermal receipt printing device (300) by the geared platen (350). In another example, it is the geared platen (350) that is spring-biased towards the spool (345) (and the roll of media) so that the geared platen (350) remains biased towards the media such that the media may be passed through the thermal receipt printing device (300) by the geared platen (350).

The door (315) may include the geared platen (350) as described herein. In a specific example, the geared platen (350) may be formed to pass the roll of media through the thermal receipt printing device (300). The roll of media may be a thermally activated paper (355) such that as the print engine (305) selectively applies heat to the thermally activated paper (355), images and/or text may be printed on the thermally activated paper (355).

The thermal receipt printing device (300) may also include a latching mechanism (325). The latching mechanism (325) may be selectively activated via use of the rotational top portion (330) of the cylindrical base housing (310) as described herein. The latching mechanism (325) may include a hook (335) formed on the cylindrical base housing (310) to engage with a peg (340) formed on the door (315). The hook (335) may engage with the peg (340) when the door (315) is pushed towards the cylindrical base housing (310). In an example, the door (315) may be opened via actuation of a button (415). The actuation of the button may be mechanically coupled to the hook (335) so as to disengaged the hook (335) from the peg (340) on the door (315).

The thermal receipt printing device (300) may also include a hinge (320) that mechanically couples the door (315) to the cylindrical base housing (310). Upon rotation of the rotational top portion (330), the latching mechanism (325) may cause the hook (335) to be decoupled from the peg (340). In this example, the hinge (320) may allow the door (315) to first be placed in a first position. That first position may be the door (315) being moved laterally away from the cylindrical base housing (310) until it reaches a maximum extension. Upon reaching the maximum extension, the hinge (320) may allow the door (315) to swing away from the cylindrical base housing (310) as described herein. This dual action of the hinge (320) allows for more of the internal portions of the thermal receipt printing device (300) such as the spool (345) and print engine (305) to be exposed. This, in turn, allows a user to more easily access these elements and any other element within the thermal receipt printing device (300) relative to other receipt printing devices. Additionally, with the door (315) and spool (345) extended away from the other elements of the thermal receipt printing device (300), the user may have more room to replace or insert the thermally activated paper (355) as described herein.

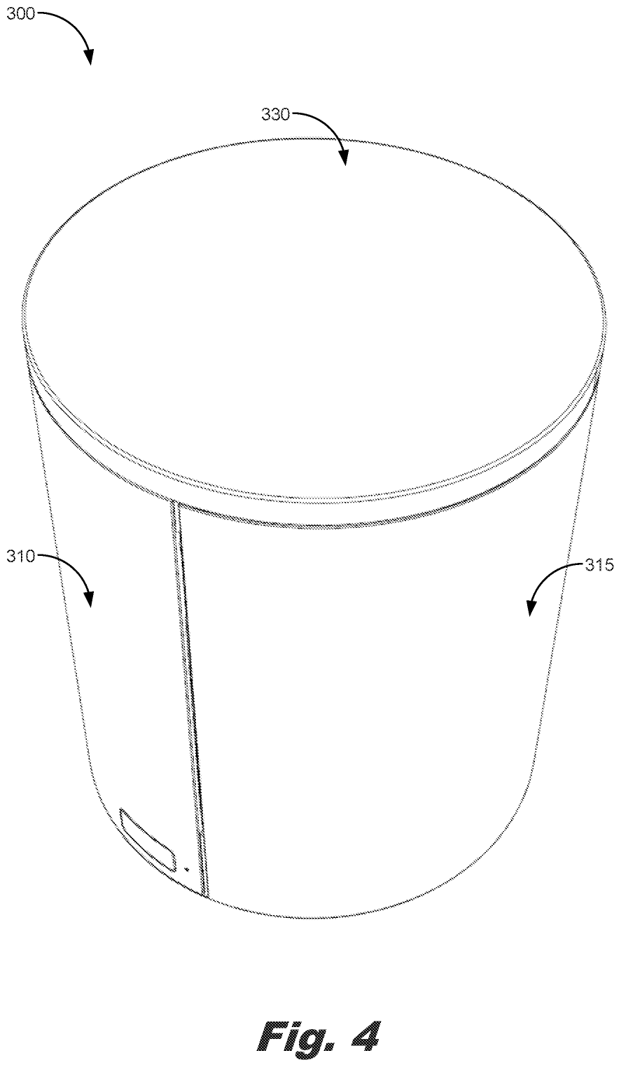

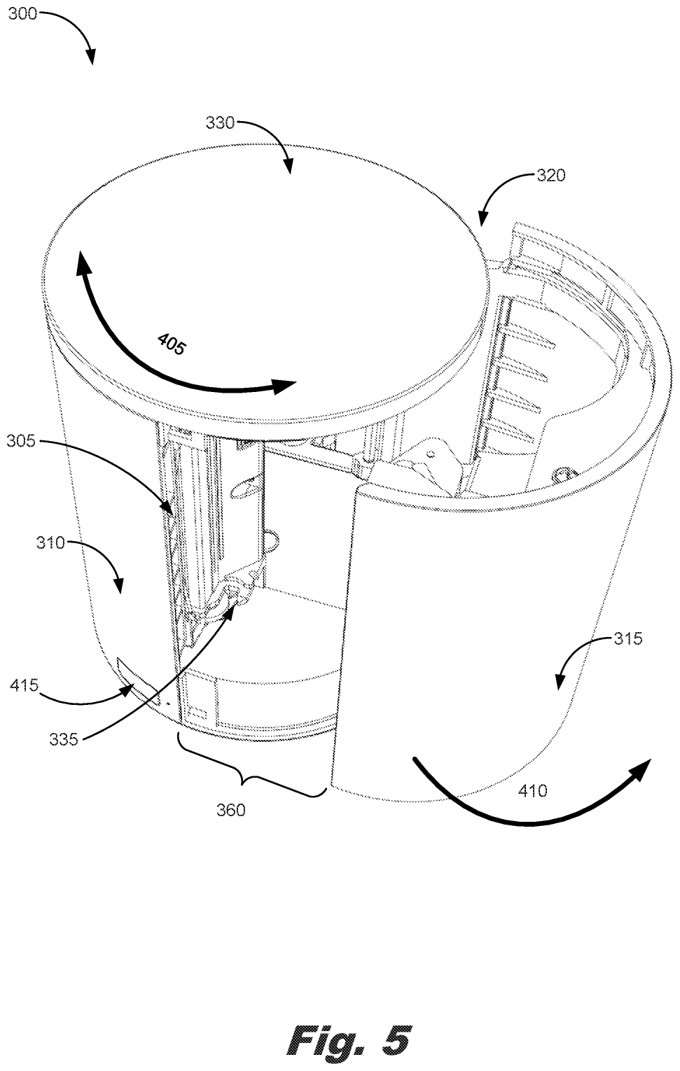

FIGS. 4 and 5 is a perspective view of the thermal receipt printing device (300) of any of FIGS. 1-3 according to an example of the principles described herein. The thermal receipt printing device (300) may include the cylindrical base housing (310) coupled to a door (315) via a hinge (320). The thermal receipt printing device (300) shows the cylindrical base housing (310) mechanically coupled to the door (315) via the hinge (320). The print engine (305) is also shown within the cylindrical base housing (310).

FIG. 5 specifically shows the hook (335) of the latching mechanism (325) as described in connection with FIG. 3. The hook (335) may interface with a peg (340) (not shown in FIG. 4 or 5) on the door (315) to put the door (315) in the position shown in FIG. 4.

As described herein, the thermal receipt printing device (300) may include a rotational top portion (330). The rotational top portion (330) may be rotated as show by arrow (405). Upon rotation of the rotational top portion (330), the hook (335) may be disengaged with the peg (340) and the door (315) may extend a distance (360) laterally from the thermal receipt printing device (300). The distance (360) may be equal to 4 mm. In an example, the distance (360) may be between 3 mm and 5 mm.

After the door (315), when unlatched is laterally moved the distance (360), the hinge (320) may allow the door (315) to hinge away from the cylindrical base housing (310). The door (315) may hinge away from the cylindrical base housing (310) in the direction shown by arrow (410). The action of the door (315) swinging away from the cylindrical base housing (310) per arrow (410) allows the internal portions of the door (315) to be exposed including the spool (345), peg (340), and geared platen (350).

In an example, the cylindrical base housing (310) may include a data/electrical port that may allow for the thermal receipt printing device (300) to be electrically and communicatively coupled to a computing device, a cash register, or any other peripheral device.

The specification and figures describe a cylindrical printing device that may be used as a POS receipt printing device. The lateral release of the door when the door has been unlatched provides for a relatively easier access to the location within the printing device for the user to load/reload the print media into the printing device. Indeed, unlike other receipt printing devices, the door may completely swing free and not be in the way of the loading/reloading process. Additionally, the two-stage opening of the door provides for unprecedented access to the internal workings of the printing device increasing user satisfaction during operation. Because the printing device is weighted, the printing device may be maintained on a counter or other support surface alone and may be interacted with regardless of whether the printing device is secured to the counter or not.

The preceding description has been presented to illustrate and describe examples of the principles described. This description is not intended to be exhaustive or to limit these principles to any precise form disclosed. Many modifications and variations are possible in light of the above teaching.

What is claimed is:

1. A vertical column printing device, comprising:
a print engine formed within a base housing of the vertical column printing device;
a door biased by a spring away from the print engine to be selectively opened to expose the print engine; and
a geared platen formed on the door to interface with the print engine to drive a roll of paper past the print engine when the door is engaged with the based housing.

2. The vertical column printing device of claim 1, comprising a spool on the door to maintain the roll of paper on the door.

3. The vertical column printing device of claim 1, comprising a latch formed on the base housing to couple with a hook formed on the door when the door is engaged with the base housing.

4. The vertical column printing device of claim 3, wherein the latch disengages with the hook when a top portion of the base housing of the vertical column printing device is rotated.

5. The vertical column printing device of claim 3, wherein when the hook is unlatched from the latch, the door extends laterally from the base housing.

6. The vertical column printing device of claim 5, wherein after the door extends laterally from the base housing the door is allowed to swing open from the base housing exposing an interior portion of the door and the print engine.

7. The vertical column printing device of claim 1, wherein the print engine is a thermal printing device and wherein the paper is a thermal paper.

8. A receipt printing device, comprising:
a base portion housing a printhead, the base portion in the form of a cylinder;
a door portion coupled to the base portion via a hinge and a latching mechanism; and
a rotational portion on top portion of the base portion that disengages the latching mechanism to unlatch the door portion from the base portion;
wherein the door portion, when unlatched, extends laterally from the cylinder base portion a distance and, upon reaching a maximum extension from the cylinder base, hinges away from the base portion housing to reveal a spool of paper on the door.

9. The receipt printing device of claim 8, wherein the latching mechanism comprises a hook formed on the base portion that interfaces with a peg formed on the door.

10. The receipt printing device of claim 9, wherein the hook disengages with the peg when the top portion of the base housing of the receipt printing device is rotated.

11. The receipt printing device of claim 8, comprising a geared platen formed on the door portion.

12. The receipt printing device of claim 11, wherein the geared platen is mechanically driven to rotate by an interfacing gear at the printhead when the door portion is latched to the base portion.

13. The receipt printing device of claim 8, wherein the base portion includes a weight formed within a bottom portion of the base portion to provide stability and resistance when the rotational portion on top portion of the base portion is rotated.

14. The receipt printing device of claim 8, wherein the distance is 4 mm.

15. A thermal receipt printing device, comprising:
a cylindrical base housing;
a print engine formed within the cylindrical base housing;
a door biased by a spring away from the print engine to be selectively opened to expose the print engine, the door comprising:
a spool to hold a roll of thermally activated paper; and
a geared platen formed on the door to interface with the print engine to drive the roll of thermally activated paper past the print engine when the door is engaged with the based housing; and
a latching mechanism comprising a hook formed on the cylindrical base housing and a peg formed on the door; and
a rotational top portion formed on the cylindrical base portion that, when rotated, disengages the peg from the hook so that the door may extend laterally from the base portion a distance and then swing away from the base portion using a hinge.
